(19) United States
(12) Patent Application Publication
(10) Pub. No.: US 2017/0116548 A1
(43) Pub. Date: Apr. 27, 2017

(54) INFORMATION PROCESSING APPARATUS, INFORMATION PROCESSING METHOD, AND PROGRAM

(71) Applicant: RAKUTEN, INC., Tokyo (JP)

(72) Inventors: Masanaka ITO, Setagaya-ku (JP); Ryohei TAKUMA, Setagaya-ku (JP)

(73) Assignee: Rakuten, Inc., Tokyo (JP)

(21) Appl. No.: 15/127,067

(22) PCT Filed: Mar. 27, 2014
(86) PCT No.: PCT/JP2014/058970

§ 371 Date: Sep. 19, 2016

(51) Int. Cl. G06Q 10/02; G06Q 10/06

(52) U.S. Cl. CPC G06Q 10/02; G06Q 10/06

(57) ABSTRACT

An information processing apparatus includes a communication unit that communicates with a plurality of user terminals and another information processing apparatus, a storage unit that stores plan information on a golf plan scheduled to be held when reservations from a predetermined number of users are accepted, and a control unit. The control unit accepts a reservation for a golf plan in which a tee time group including a plurality of tee times on a predetermined date is specified, via a first website from each of the user terminals through the communication unit, schedules the golf plan to be held such that the golf plan is started at a first tee time selected from the tee time group, when the reservations from the predetermined number of users are accepted, sends a reservation acceptance request to the other information processing apparatus through the communication unit, the reservation acceptance request requesting acceptance of a reservation for the golf plan via a second website, when the golf plan is not scheduled to be held via the first website at a predetermined time point before the predetermined date, and schedules the golf plan to be held such that the golf plan is started at the first tee time, when a sum of the number of reservations for the golf plan via the first website and the number of reservations for the golf plan via the second website reaches the predetermined number.

### TECHNICAL FIELD

The present invention relates to an information processing apparatus capable of providing services to accept reservations for golf courses on the Internet, an information processing method in the information processing apparatus, and a program.

### BACKGROUND ART

There have been services capable of accepting reservations for golf courses on the Internet in the past. Those services may accept a reservation of one user (one-person reservation), in addition to a normal reservation in which the minimum number of users is set (in general, one user makes reservations of user's companion as well).

In the one-person reservation, for a plan (reservation slot) that is started in a certain golf course on a certain date, reservations are accepted on a user basis, and when the number of reservations reaches the minimum number of users, the plan is scheduled to be held. Therefore, in the case where the number of reservations does not reach the minimum number of users, the plan is not scheduled to be held and the reservations of the users are wasted. The users lose the opportunity to join the plan.

In this regard, Patent Document 1 below discloses an information processing apparatus that: searches for, in the case where there is a first reservation slot whose number of reservations is less than the minimum number of users, such a reservation slot that a sum of the number of reservations for the reservation slot and the number of reservations for the first reservation slot is the minimum number of users or more, from second reservation slots having reservations; and outputs an information to prompt a user who has made a reservation for the first reservation slot or the second reservation slot to switch the reservation to the other reservation slot.

Patent Document 1: Japanese Patent No. 5298262

### SUMMARY OF INVENTION

### Problem to be Solved by the Invention

However, the technology of Patent Document 1 described above imposes reservation processing for the first reservation slot or the second reservation slot and switch processing to the other reservation slot on the user. This requires time and effort of the user.

In view of the circumstances as described above, it is an object of the present invention to provide an information processing apparatus, an information processing method, and a program that are capable of improving a rate of scheduled golf plan without increasing time and effort of a user in a one-person golf reservation service.

### Means for Solving the Problem

To solve the problem described above, according to an embodiment of the present invention, there is provided an information processing apparatus including a communication unit, a storage unit, and a control unit. The communication unit is capable of communicating with a plurality of user terminals and another information processing apparatus. The storage unit stores plan information on a golf plan scheduled to be held when reservations from a predetermined number of users are accepted. The control unit is capable of accepting a reservation for a golf plan in which a tee time group including a plurality of tee times on a predetermined date is specified, via a first website from each of the user terminals through the communication unit, and scheduling the golf plan to be held such that the golf plan is started at a first tee time selected from the tee time group, when the reservations from the predetermined number of users are accepted. Further, the control unit is capable of sending a reservation acceptance request to the other information processing apparatus through the communication unit, the reservation acceptance request requesting acceptance of a reservation for the golf plan via a second website, when the golf plan is not scheduled to be held via the first website at a predetermined time point before the predetermined date, and scheduling the golf plan to be held such that the golf plan is started at the first tee time, when a sum of the number of reservations for the golf plan via the first website and the number of reservations for the golf plan via the second website reaches the predetermined number.

The information processing apparatus can thus accept reservations by not a specific tee time but a tee time group with a time range, and schedule a plan at any tee time to be held, to increase a rate of scheduled plan without increasing time and effort of a user. In the case where the plan is not scheduled to be held immediately before an estimated date for the holding of the plan, the information processing apparatus can cooperate with another golf reservation service via the second website to increase the parameter of users making reservations, and can add the number of reservations in the cooperation destination, to further increase the rate of scheduled plan. Here, the first website and the second website may be operated by different providers.

The control unit may schedule a golf plan to be held such that the golf plan is started at a second tee time selected from the tee time group excluding the first tee time, when the number of reservations for the golf plan via the first website reaches the predetermined number after the golf plan started at the first tee time is scheduled to be held and at a time point before the predetermined time point.

The information processing apparatus can thus schedule golf plans at a plurality of tee times included in the tee time group to be held as much as possible, at a time point before the predetermined time point.

The control unit may schedule a golf plan to be held such that the golf plan is started at a second tee time selected from the tee time group excluding the first tee time, when a sum of the number of reservations for the golf plan via the first website and the number of reservations for the golf plan via the second website reaches the predetermined number after the golf plan started at the first tee time is scheduled to be held.

The information processing apparatus can thus schedule golf plans at a plurality of tee times included in the tee time group to be held as much as possible, at a time point after the predetermined time point.

The storage unit may store scheduled-plan history information of past golf plans on a golf-course basis. In this case, the control unit may set, based on the scheduled-plan history information, the predetermined time point on a golf-course basis such that a golf course having a lower rate of scheduled plan has a larger interval between the predetermined time point and the predetermined date.

The information processing apparatus can thus wait by a time point immediately before the predetermined date to start cooperating with the second website regarding a golf course having a high rate of scheduled plan, whereas the information processing apparatus can set cooperation with the second website to be started early regarding a golf course having a low rate of scheduled plan, to thus make it possible to increase a rate of scheduled plan while securing the number of reservations in the first website alone as much as possible.

The storage unit may store user information including resident area information of a user, and reservation history information of past golf plans on a golf-course basis and on a user basis. In this case, the control unit may accept, based on the reservation history information and the reservation history information, a reservation for a golf plan in which a golf course group is specified, the golf course group including a plurality of golf courses for which the user has made a reservation two times or more among a plurality of golf courses in a predetermined area corresponding to the resident area information, via the first website from each of the user terminals through the communication unit, and may schedule a golf plan to be held such that the golf plan is started at the first tee time in a first golf course of the golf course group, when the reservations from the predetermined number of users are accepted at a time point before the predetermined time point.

The information processing apparatus can thus provide ranges of reservations to golf courses as well, and limit a golf course for which a user has made a reservation two times or more, that is, with which it is supposed that the user does not have a bad impression, to thus make it possible to improve a rate of scheduled golf plan that matches a preference of the user.

The control unit may schedule the golf plan to be held such that the golf plan is started at the first tee time in the first golf course, when a sum of the number of reservations for the golf plan via the first website and the number of reservations for the golf plan via the second website reaches the predetermined number at a time point after the predetermined time point.

The information processing apparatus can thus provide ranges of reservations for golf courses in the second website as well after the predetermined time point, to thus make it possible to further increase a rate of scheduled golf plan that matches a preference of the user.

According to another embodiment of the present invention, there is provided an information processing method including: storing plan information on a golf plan scheduled to be held when reservations from a predetermined number of users are accepted; accepting a reservation for a golf plan in which a tee time group including a plurality of tee times on a predetermined date is specified, via a first website from each of the user terminals; scheduling the golf plan to be held such that the golf plan is started at one tee time selected from the tee time group, when the reservations from the predetermined number of users are accepted; sending a reservation acceptance request to another information processing apparatus, the reservation acceptance request requesting acceptance of a reservation for the golf plan via a second website, when the golf plan is not scheduled to be held via the first website at a predetermined time point before the predetermined date; and scheduling the golf plan to be held such that the golf plan is started at the one tee time, when a sum of the number of reservations for the golf plan via the first website and the number of reservations for the golf plan via the second website reaches the predetermined number.

According to still another embodiment of the present invention, there is provided a program causing an information processing apparatus to execute the steps of: storing plan information on a golf plan scheduled to be held when reservations from a predetermined number of users are accepted; accepting a reservation for a golf plan in which a tee time group including a plurality of tee times on a predetermined date is specified, via a first website from each of the user terminals; scheduling the golf plan to be held such that the golf plan is started at one tee time selected from the tee time group, when the reservations from the predetermined number of users are accepted; sending a reservation acceptance request to another information processing apparatus, the reservation acceptance request requesting acceptance of a reservation for the golf plan via a second website, when the golf plan is not scheduled to be held via the first website at a predetermined time point before the predetermined date; and scheduling the golf plan to be held such that the golf plan is started at the one tee time, when a sum of the number of reservations for the golf plan via the first website and the number of reservations for the golf plan via the second website reaches the predetermined number.

As described above, according to the present invention, it is possible to increase a rate of scheduled golf plan without increasing time and effort of a user in a one-person golf reservation service. However, the effects described herein do not necessarily limit the present invention.

### BRIEF DESCRIPTION OF DRAWINGS

FIG. 1 is a diagram showing a configuration of a golf reservation system according to an embodiment of the present invention.

FIG. 2 is a diagram showing a hardware configuration of a golf course reservation server in the system.

FIG. 3 is a diagram showing a database configuration of the golf course reservation server.

FIG. 4 is a flowchart showing a flow of processing of one-person reservation for a golf course by the golf course reservation server.

FIG. 5 is a diagram showing an example of a search page of a one-person reservation plan, which is generated by the golf course reservation server and displayed on a user terminal.

FIG. 6 is a diagram showing an example of a search results page of the one-person reservation plan, which is generated by the golf course reservation server and displayed on the user terminal.

FIG. 7 is a diagram showing an example of a scheduled-plan notification page of the one-person reservation plan, which is generated by the golf course reservation server and displayed on the user terminal.

### MODE(S) FOR CARRYING OUT THE INVENTION

Hereinafter, an embodiment of the present invention will be described with reference to the drawings.

[Configuration of System]

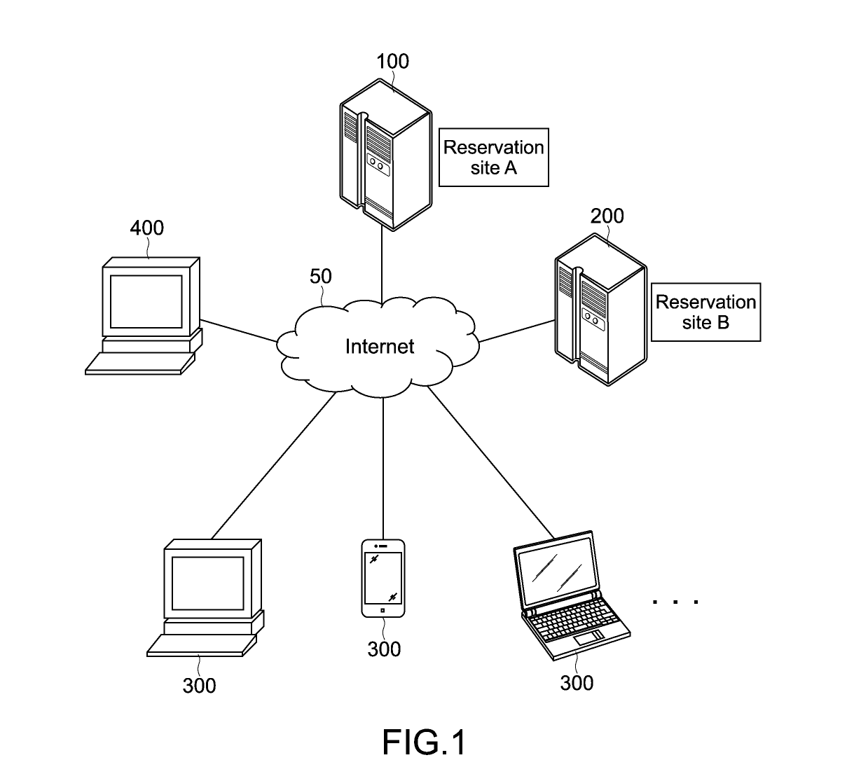

FIG. 1 is a diagram showing a configuration of a golf reservation system according to this embodiment.

As shown in FIG. 1, the system includes a golf course reservation server 100 and a golf course reservation server 200 on the Internet 50, a plurality of user terminals 300, and a golf course terminal 400.

The golf course reservation server 100 is a server that is managed by a company operating a golf course reservation site (reservation site A). The golf course reservation server 100 is connected to the golf course reservation server 200, the user terminals 300, and the golf course terminal 400 via the Internet 50.

The golf course reservation server 200 is a server that is managed by an operating company different from an operating company different from the operator of the golf course reservation server 100, for example. The golf course reservation server 200 provides a golf course reservation site (reservation site B) that is different from the golf course reservation site A provided by the golf course reservation server 100.

In FIG. 1, only one golf course reservation server 200 is shown other than the golf course reservation server 100, but a plurality of golf course reservation servers may be present.

Each of the user terminals 300 is a terminal used by a user who makes a reservation for golf, and is a smartphone, a mobile phone, a tablet PC (Personal Computer), a laptop PC, or a desktop PC, for example.

In response to access requests to the golf course reservation sites from the user terminals 300, the golf course reservation server 100 and the golf course reservation server 200 each generate a web page (HTML (HyperText Markup Language) document) including pieces of golf plan information and the like and send the web page back to each user terminal 300.

Each of the user terminals 300 accesses the golf course reservation server 100 or the golf course reservation server 200 and receives the web page, to display the web page on a screen by a browser.

The user of the user terminal 300 executes processing of making a reservation for a specific golf plan via the screen displayed by the browser.

The golf course terminal 400 is a terminal device used by persons engaged in golf courses or the like and is a PC, for example. The golf course terminal 400 can access the golf course reservation server 100 or the golf course reservation server 200 to acquire a status of reservations for golf courses of the golf course terminal 400. The reservations are made from the user terminals 300, and the like.

Further, the golf course reservation server 100 and the golf course reservation server 200 can accept a reservation of one user (one-person reservation), in addition to a normal reservation in which the minimum number of users is set (in general, one user makes reservations of user's companion as well).

In the one-person reservation, reservations are accepted on a user basis for a certain plan (reservation slot) in a certain golf course, and at the time the number of reservations reaches the minimum number of users, the plan is scheduled to be held.

In this embodiment, the processing of the golf course reservation server 100 and the golf course reservation server 200 on the one-person reservation will be mainly described.

[Hardware Configuration of Golf Course Reservation Server]

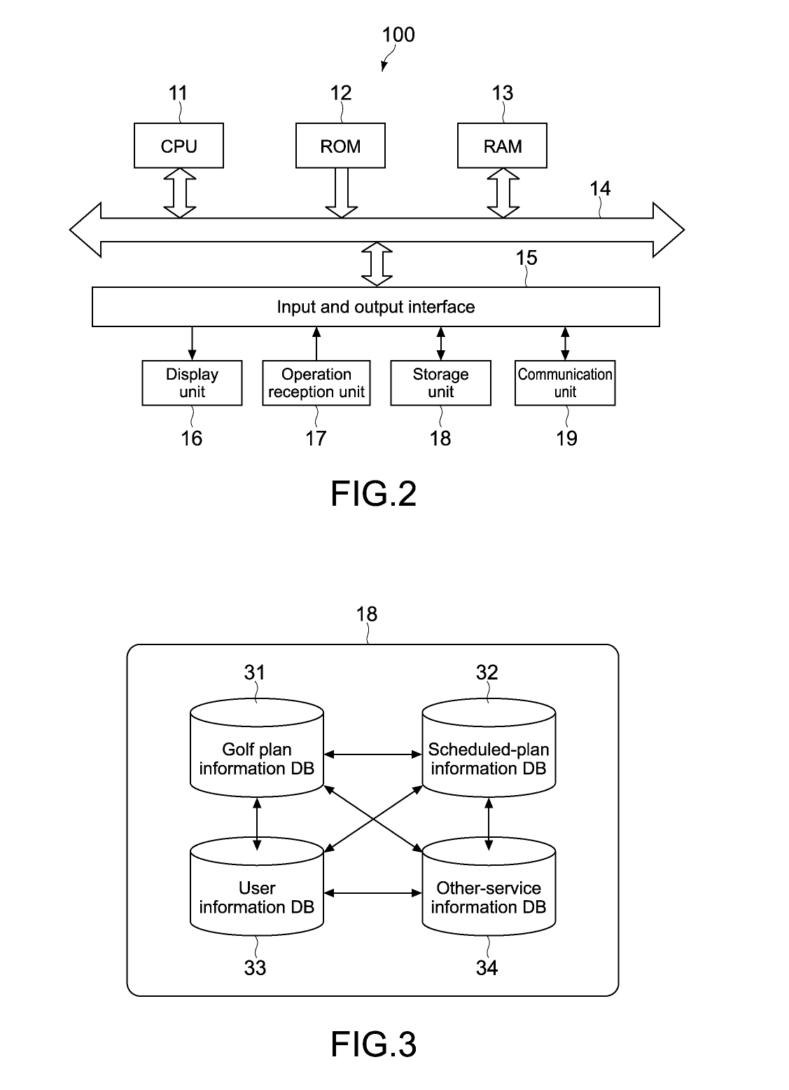

FIG. 2 is a diagram showing a hardware configuration of the golf course reservation server 100. As shown in FIG. 2, the golf course reservation server 100 includes a CPU (Central Processing Unit) 11, a ROM (Read Only Memory) 12, a RAM (Random Access Memory) 13, an input and output interface 15, and a bus 14 that connects those components to one another.

The CPU 11 appropriately accesses the RAM 13 and the like when necessary and performs overall control of the whole blocks of the golf course reservation server 100 while performing various types of computation processing. The ROM 12 is a non-volatile memory in which an OS to be executed by the CPU 11, and firmware such as a program and various parameters are fixedly stored. The RAM 13 is used as a work area or the like of the CPU 11 and temporarily holds the OS, various applications being executed, or various types of data being processed.

A display unit 16, an operation reception unit 17, a storage unit 18, a communication unit 19, and the like are connected to the input and output interface 15.

The display unit 16 is a display device using, for example, an LCD (Liquid Crystal Display), an OELD (Organic Electroluminescence Display), or a CRT (Cathode Ray Tube).

The operation reception unit 17 is an input device, for example, a pointing device such as a mouse, a keyboard, or a touch panel. In the case where the operation reception unit 17 is a touch panel, the touch panel may be integrated with the display unit 16.

The storage unit 18 is a non-volatile memory, for example, an HDD (Hard Disk Drive), a flash memory (SSD; Solid State Drive), or any other solid-state memory. The storage unit 18 stores the OS, various applications, and various types of data.

As will be described later, particularly in this embodiment, the storage unit 18 includes a golf plan information database on golf plans that are currently available for reservation in the golf course reservation server 100, a scheduled-plan information database on golf plans that were scheduled to be held in the past, a user information database on addresses or past reservation histories of the users of the user terminals 300, and an other-service information database on golf plans that are available for reservation or whose reservations were accepted in the past in the golf course reservation server 200 via another golf course reservation site.

The communication unit 19 is a NIC (Network Interface Card) for the Ethernet (registered trademark), for example. The communication unit 19 handles processing of communication with the user terminals 300, the golf course reservation server 200, and the golf course terminal 400.

The hardware configuration of the golf course reservation server 200 is similar to that of the golf course reservation server 100, though not shown in the figures.

[Database Configuration of Golf Course Reservation Server]

FIG. 3 is a diagram showing a database configuration of the golf course reservation server 100.

As shown in FIG. 3, the golf course reservation server 100 includes a golf plan information database 31, a scheduled-plan information database 32, a user information database 33, and an other-service information database 34 in the storage unit 18.

The golf plan information database 31 stores information on normal golf plans (slots) and one-person reservation plans that are currently available for reservation in the golf course reservation server 100, specifically, information such as a name of golf course, a green fee, the location of a golf course, a nearest interchange, an evaluation, the date of a plan to be held, with or without a lunch, with or without a caddie, the type of cart, the minimum number of users, and a current status of reservation acceptance (the number of users having made reservations).

The scheduled-plan information database 32 stores information on whether the past golf plans were scheduled to be held or not, a rate of the scheduled golf plan, and the like, on a golf-course basis.

The user information database 33 stores information such as a user's name, a user's ID, an address of the user, and a golf course reservation history of the user.

The other-service information database 34 stores golf plans that are currently available for reservation in the golf course reservation site of the golf course reservation server 200, and reservation statuses of the golf plans (e.g., the number of users having made reservations on a plan basis).

[Operation of Golf Course Reservation Server]

Next, the operation of the golf course reservation server 100 configured as described above will be described. This operation is executed in cooperation of hardware, such as the CPU 11 and the communication unit 19, and software stored in the storage unit 18, in the golf course reservation server 100. In the following description, the CPU 11 is an actor of the operation for convenience sake.

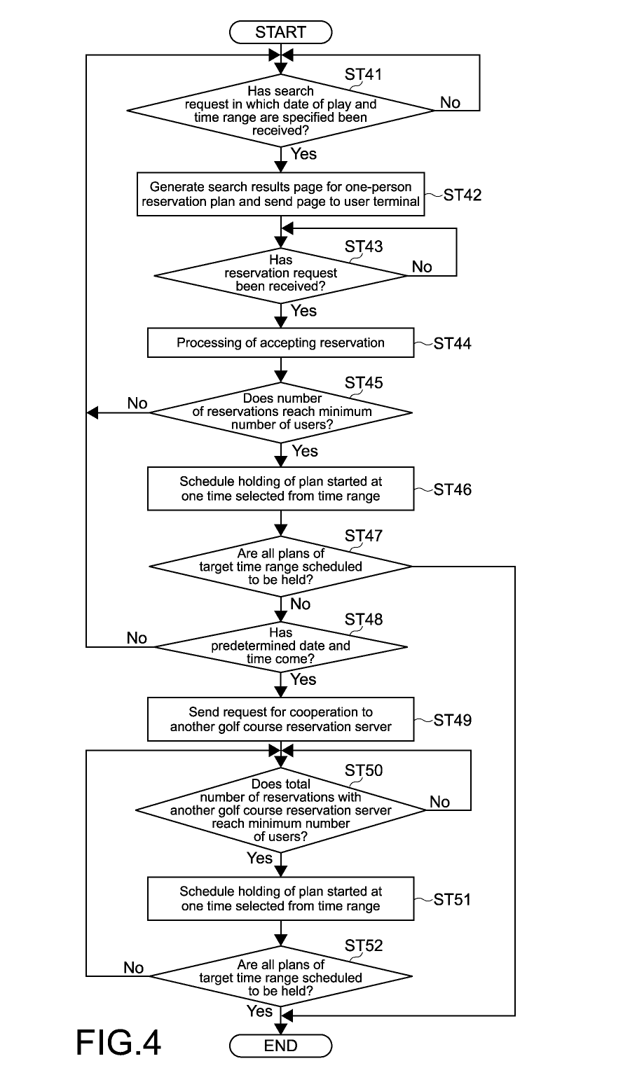

FIG. 4 is a flowchart showing a flow of processing of one-person reservation for a golf course by the golf course reservation server 100.

On reception of a request to display a one-person reservation plan search page from the user terminal 300 via the reservation site A, the CPU 11 of the golf course reservation server 100 generates a one-person reservation plan search page and sends the one-person reservation plan search page to the user terminal 300.

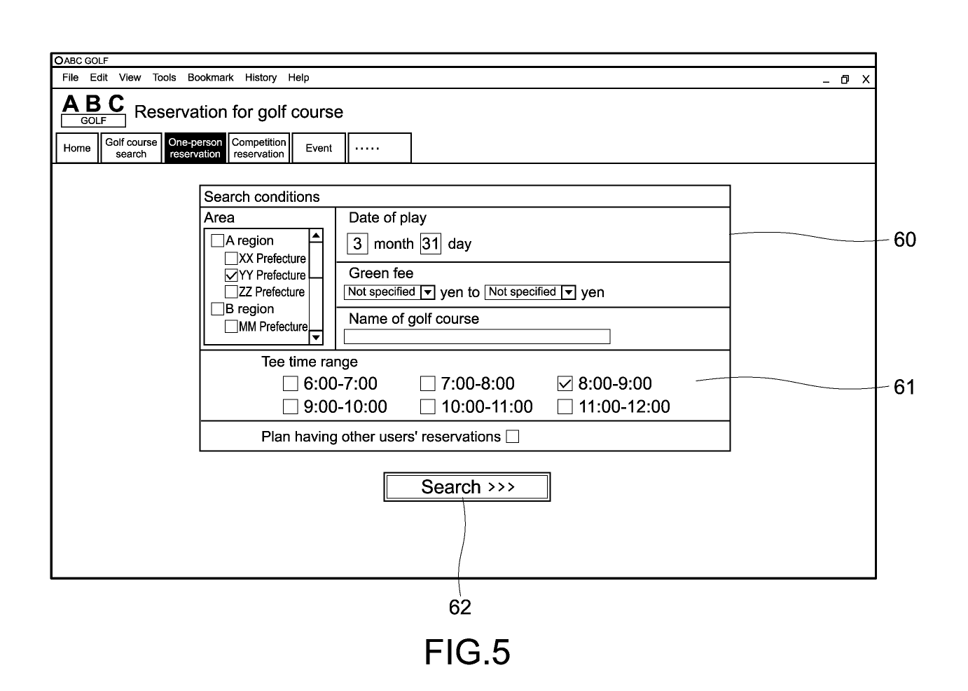

FIG. 5 is a diagram showing an example of a search page generated to be displayed in the user terminal 300.

As shown in FIG. 5, the search page includes a search condition setting area 60 in which a tee time range, a plan having other users' reservations, and the like can be specified as search conditions, in addition to an area of golf courses available for one-person reservation, the date of play, a green fee, and a name of golf course, for example. As a matter of course, the search conditions are not limited to those above. For example, profiles (score, gender, age, etc.) of users who already made reservations for the plan (the users becoming companions if the plan is scheduled to be held) may be specified as search conditions.

The tee time range is selectable in a tee time range selection area 61, for example, on an hourly basis, e.g., between 7:00 and 8:00, between 8:00 and 9:00, and between 9:00 and 10:00. Each time range is a time group including a plurality of tee times (e.g., in the case between 8:00 and 9:00, 8:07, 8:21, 8:28, 8:35, 8:42, etc.).

The tee times within the time range may differ depending on golf courses, but specifying a time range suffices for the search page, and thus the tee times are not displayed therein.

As shown in FIG. 4, the CPU 11 determines whether a search request in which at least the date of play and a tee time range are specified as search conditions has been received or not from the search page (Step 41). In the example of FIG. 5, a plan in a golf course located in an A region of YY Prefecture on March 31st starting between 8:00 and 9:00 is selected as search conditions. In this status, when a search button 62 is pressed from the user terminal 300, a search request is sent from the user terminal 300 to the golf course reservation server 100.

When determining that the search request has been received (Yes), the CPU 11 searches the golf plan information database 31 for a one-person reservation plan that matches the search conditions, generates a search results page showing a list of the results, and sends the search results page back to the user terminal 300 (Step 42). In the case where there are no plans that match the search conditions, a search results page indicating that there are no plans is sent back to the user terminal 300.

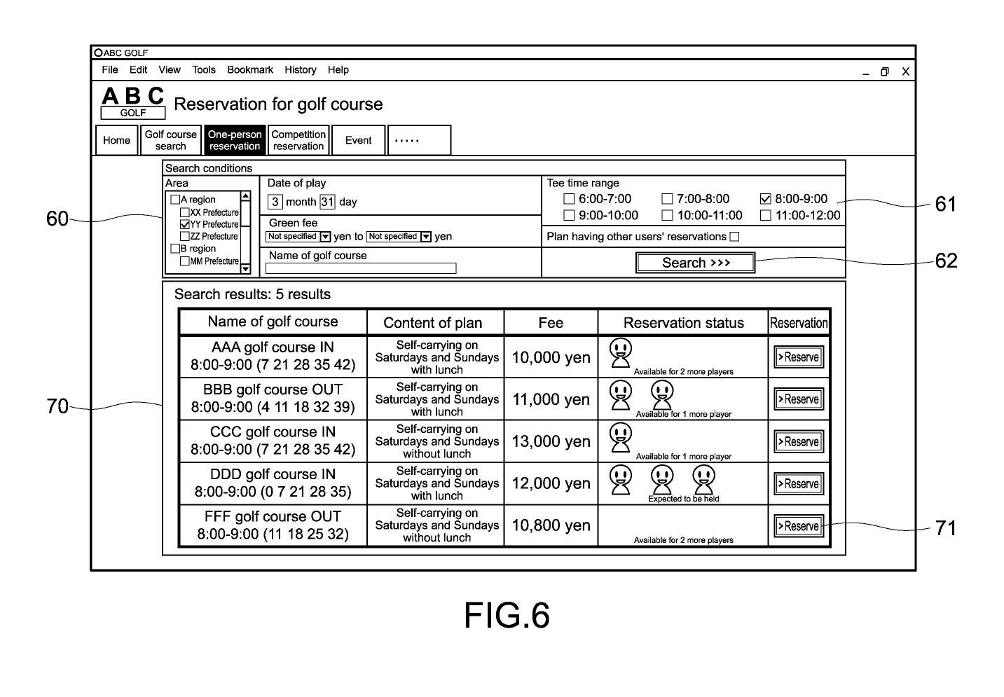

FIG. 6 is a diagram showing an example of a search results page of the one-person reservation plan, which is generated to be displayed on the user terminal 300.

As shown in FIG. 6, the search results page includes a search results list area 70 in addition to the search condition setting area 60.

The search results list area 70 includes, for each one-person reservation plan that matches the search conditions, the name of golf course, the content of plan, a fee, a reservation status, and a reservation button 71, for example.

The reservation status shows how many users have made reservations for that plan at the moment. The reservation status is expressed by the number of images representing persons, for example. Further, the minimum number of users is set for each plan. The list also shows information indicating how many reservations of users are necessary to schedule the plan to be held, in accordance with the minimum number of users and the reservation status of each plan.

Referring back to FIG. 4, the CPU 11 determines whether a reservation request of a specific plan has been received from the user terminal 300 by a press of the reservation button 71, the press being made by the user from the search results page (Step 43).

When determining that the reservation request has been received (Yes), the CPU 11 executes processing of accepting a reservation for the plan. Specifically, the CPU 11 stores in the golf plan information database 31 information on the user who has made the reservation, and increments the number of users having made reservations.

Subsequently, the CPU 11 determines whether the number of reservations for the plan for which reservations have been accepted reaches the minimum number of users or not (Step 45).

When determining that the number of reservations reaches the minimum number of users (Yes), the CPU 11 schedules a plan to be held, the plan being started at any one of tee times within the tee time range specified in the reservation target plan (Step 46). Specifically, the CPU 11 randomly selects one of the plurality of tee times, for example, and sets a flag to be on, the flag indicating whether the plan started at that time is scheduled to be held or not.

Subsequently, the CPU 11 determines whether the plan is scheduled to be held or not for all the tee times included in the tee time range specified in the reservation target plan (Step 47).

When determining that the plan is scheduled to be held for all the tee times (Yes), the CPU 11 terminates the processing.

When determining that the plan is not scheduled to be held for all the tee times, that is, there are times at which the plan is not scheduled to be held in the specified tee time range (No), the CPU 11 determines whether a predetermined date and time has come or not (Step 48).

The predetermined date and time is a specific date and time at a predetermined time before the specified date of play, for example, 24 hours or 48 hours before the date of play.

When determining that the predetermined date and time has not yet come (No), the CPU 11 repeats the processing from Step 41 to Step 46 until reservations from other users are accepted and the plan is thus scheduled to be held for all the tee times.

When determining that the predetermined date and time has come in a state where the plan is not scheduled to be held for all the tee times (Yes of Step 48), the CPU 11 sends a request for starting cooperation processing to the other golf course reservation server 200 (Step 49).

In other words, the CPU 11 sends information to the golf course reservation server 200, the information requesting acceptance of a reservation for a plan in the reservation site B as well, the plan including times at which the plan is not scheduled to be held.

In response to the request, the golf course reservation server 200 permits the acceptance of the reservation for the plan in the reservation site B of the golf course reservation server 200. Specifically, in the case where a plan is searched for in a search page in the reservation site B, the search page being similar to that of FIG. 5 (design thereof may be different), the golf course reservation server 200 sends back a search results page in response to the request of the user terminal 300 such that the plan displayed as shown in FIG. 6 in the reservation site A is displayed on the search results page for that search page.

In other words, in the reservation site B provided by the golf course reservation server 200, the plan is not shown in search results at a time point before the predetermined date and time, but after the predetermined date and time has passed and target plan information is generated based on the request from the golf course reservation server 100, the plan is displayed in the search results.

At that time point as well, the golf course reservation server 100 continues accepting reservations for the plan via the reservation site A of the golf course reservation server 100. Further, from this point forward, the golf course reservation server 100 is capable of receiving information on the status of reservation acceptance of the plan in the golf course reservation server 200 from the golf course reservation server 200 in real time, for example.

Subsequently, the CPU 11 determines whether a sum of the number of reservations for the plan in the golf course reservation server 100 and the number of reservations for the same plan in the golf course reservation server 200 reaches the minimum number of users or not (Step 50).

When determining that a sum of the number of reservations reaches the minimum number of users (Yes), the CPU 11 schedules the plan to be held, the plan being started at any one of tee times within the tee time range that is specified in the reservation target plan but excludes the tee times for which the plan is scheduled to be held (Step 51). Specifically, the CPU 11 sets a flag to be on, the flag indicating whether a plan, which is started at a tee time (in the case where there are a plurality of tee times, randomly-selected one of the tee times, for example) other than the tee times for which the plan is scheduled to be held, is scheduled to be held or not.

Subsequently, the CPU 11 determines whether the plan is scheduled to be held or not for all the tee times included in the tee time range specified in the reservation target plan (Step 52).

When determining that the plan is scheduled to be held for all the tee times (Yes), the CPU 11 terminates the processing.

When determining that there are tee times for which the plan is not scheduled to be held in the tee time range (No), the CPU 11 repeats the processing of Step 50 and the following steps until the plan is scheduled to be held for all the tee times and by a time available for reservation (for example, by 0:00 of the date of play).

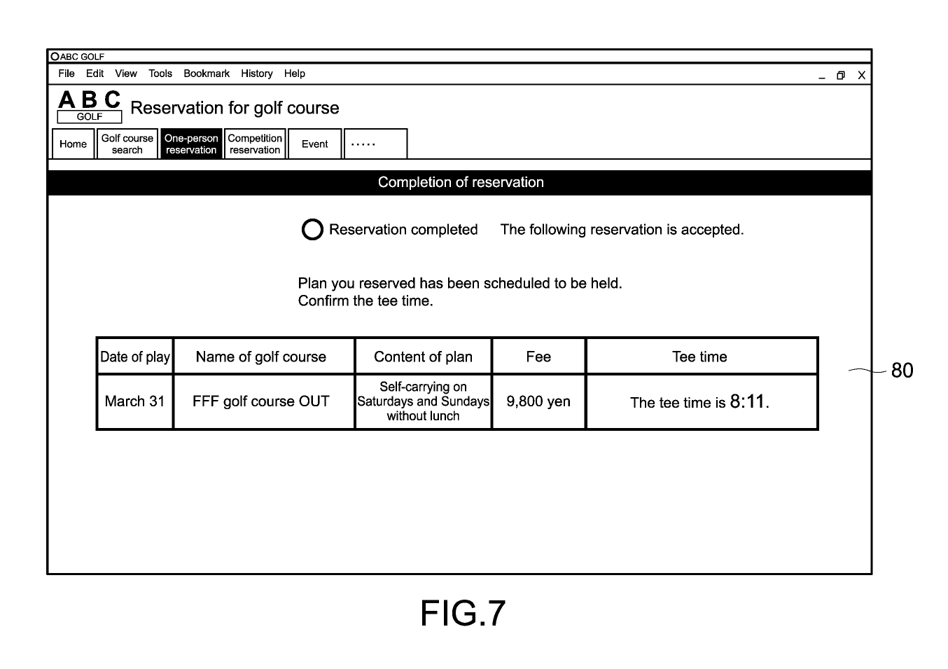

In the case where the plan at any tee time is scheduled to be held, the user is notified of the plan scheduled to be held, via the reservation site A. FIG. 7 is a diagram showing an example of a scheduled-plan notification page of the one-person reservation plan, which is generated by the golf course reservation server 100 and displayed on the user terminal 300.

As shown in FIG. 7, in a scheduled-plan notification page 80, the facts that the reservation of the user is accepted and that the plan is scheduled to be held by that reservation are displayed together with detailed information on the plan and a selected tee time.

Such a page is an example of a notification in a case where the plan is scheduled to be held at the time point of the reservation processing by the user. In the case where the plan is not scheduled to be held at the time point of the reservation processing by the user and is thereafter scheduled to be held by reservations in the reservation site A or a sum of the number of reservations in the reservation site A and the number of reservations in the reservation site B, the user is notified of information indicating that the plan is scheduled to be held, together with tee time information, by My page of the user in the reservation site A or e-mail, for example.

In such a manner, according to this embodiment, the golf course reservation server 100 can accept a reservation for a golf plan of one-person reservation, in which not a specific tee time on a specific date of play but a tee time range (time group) including a plurality of tee times is specified, and can schedule the plan to be held at any one of the tee times in the case where the number of reservations reaches the minimum number of users, to increase a rate of scheduled plan without increasing time and effort of the user. Further, in the case where the plan is not scheduled to be held immediately before an estimated date for the holding of the plan, the golf course reservation server 100 can cooperate with a golf reservation service via the reservation site B that is operated by the other golf course reservation server 200 to increase the parameter of users making reservations, and can add the number of reservations in the cooperation destination, to further increase the rate of scheduled plan.

### Modified Example

The present invention is not limited to the embodiment described above and can be variously modified without departing from the gist of the present disclosure.

In the embodiment described above, the predetermined date and time at which cooperation with the other golf course reservation server 200 is started is fixed (for example, 24 hours before the date on which the plan is held). However, the predetermined date and time may differ depending on golf courses. In other words, the golf course reservation server 100 may refer to the past scheduled-plan information database 32 on a golf-course basis, to set a predetermined date and time on a golf-course basis such that a golf course having a lower rate of scheduled plan has a larger interval between the predetermined date and time and an estimated date for the holding of the golf plan. For example, in the case of a certain golf course A, cooperation with the other golf course reservation server 200 is started 24 hours before the estimated date for the holding of the plan, whereas in the case of another golf course B having a lower rate of scheduled plan than the golf course A, cooperation with the other golf course reservation server 200 may be started 48 hours before the estimated date for the holding of the plan.

Consequently, regarding a golf course having a high rate of scheduled plan, the golf course reservation server 100 does not cooperate with the other golf course reservation server 200 immediately before the estimated date for the holding of the plan, and schedules the plan to be held as much as possible by reservations made via the reservation site A of the golf course reservation server 100, to maximize its own profit. On the other hand, regarding a golf course having a low rate of scheduled plan, the golf course reservation server 100 can start cooperation early, to thus secure the minimum profit while having priority to schedule a plan to be held.

In the embodiment described above, a specific golf course is specified in the reservation from the user terminal 300, but a reservation range may be set for the golf course as well. In other words, in the case where the golf course reservation server 100 receives from the user terminal 300 a search request in which a golf course is not specified but the date of play and a tee time range are specified in a search page, the golf course reservation server 100 refers to a resident area (address) and the past reservation history of the user from the user information database 33, and sends back a search results page including golf plans as search results. In the golf plans, a golf course group is specified. The golf course group includes a plurality of golf courses for which the user has made a reservation two times or more among a plurality of golf courses corresponding to the resident area of the user (for example, within a predetermined distance from the resident area). The golf course reservation server 100 then accepts a request of making a reservation for this plan, and when the number of reservations reaches the minimum number of users, schedules the plan to be held, the plan being started at one tee time selected from the specified tee time range in one golf course randomly selected from the golf course group, for example.

In this case, the golf course reservation server 100 accepts reservations only in the reservation site A thereof at the time point before the predetermined date and time, and when the number of reservations reaches the minimum number of users, schedules the plan to be held. On the other hand, in the case where there are golf courses and tee times for which the plan is not scheduled to be held after the predetermined date and time has passed, the golf course reservation server 100 cooperates with the other golf course reservation server 200. In the case where a sum of the number of reservations for the plan described above in the reservation site A and the number of reservations for the plan in the reservation site B reaches the minimum number of users, a plan that is started in any golf course for which the plan is not scheduled to be held and at any tee time is scheduled to be held.

Consequently, the golf course reservation server 100 accepts reservations provided with ranges for not only the tee times but also the golf courses, and thus can increase the rate of scheduled golf plan. In addition, a golf course to be selected is within a predetermined distance from the resident area of the user and is also a golf course for which the user has made a reservation two times or more, that is, with which it is presumed that the user does not have a bad impression. Thus, a golf course that matches the convenience and preference of the user is selected without requiring the time and effort of the user.

The condition described above, “user has made a reservation two times or more”, may be excluded in some cases. For example, in the case where the user makes a reservation for the first time or the second reservation in the reservation site A or the reservation site B, a history of reservations made two times or more does not exist in the first place. Thus, only the resident area of the user may be set as a condition to select a golf course.

In the embodiment described above, reservations are accepted via the reservation site A and the reservation site B provided by the golf course reservation server 100 and the golf course reservation server 200, respectively. For example, reservations may be accepted by a golf course reservation application installed in the user terminal 300, and information on the acceptance may be sent to the golf course reservation server 100 and the golf course reservation server 200. In this case, the golf course reservation application may include various databases required for the reservation processing and the processing of scheduling plans to be held, as shown in FIG. 3, or may access databases of the golf course reservation server 100 and the golf course reservation server 200 as appropriate.

### DESCRIPTION OF REFERENCE NUMERALS

11 CPU
18 storage unit
19 communication unit
31 golf plan information database
32 scheduled-plan information database
33 user information database
34 other-service information database
50 Internet
60 search condition setting area
61 tee time range selection area
62 search button
70 search results list area
71 reservation button
80 scheduled-plan notification page
100, 200 golf course reservation server
300 user terminal
400 golf course terminal

1. An information processing apparatus, comprising:
a communication unit configured to communicate with a plurality of user terminals and another information processing apparatus;
a storage unit configured to store plan information on a golf plan scheduled to be held when reservations from a predetermined number of users are accepted; and
a control unit configured to
accept a reservation for a golf plan in which a tee time group including a plurality of tee times on a predetermined date is specified, via a first website from each of the user terminals through the communication unit,
schedule the golf plan to be held, the golf plan being started at a first tee time selected from the tee time group, when the reservations from the predetermined number of users are accepted,
send a reservation acceptance request to the other information processing apparatus through the communication unit, the reservation acceptance request requesting acceptance of a reservation for the golf plan via a second website, when the golf plan is not scheduled to be held via the first website at a predetermined time point before the predetermined date, and
schedule the golf plan to be held, the golf plan being started at the first tee time, when a sum of the number of reservations for the golf plan via the first website and the number of reservations for the golf plan via the second website reaches the predetermined number.

2. The information processing apparatus according to claim 1, wherein
the control unit schedules a golf plan to be held, the golf plan being started at a second tee time selected from the tee time group excluding the first tee time, when the number of reservations for the golf plan via the first website reaches the predetermined number after the golf plan started at the first tee time is scheduled to be held and at a time point before the predetermined time point.

3. The information processing apparatus according to claim 1, wherein
the control unit schedules a golf plan to be held, the golf plan being started at a second tee time selected from the tee time group excluding the first tee time, when a sum of the number of reservations for the golf plan via the first website and the number of reservations for the golf plan via the second website reaches the predetermined number after the golf plan started at the first tee time is scheduled to be held and at a time point after the predetermined time point.

4. The information processing apparatus according to claim 1, wherein
the storage unit stores scheduled-plan history information of past golf plans on a golf-course basis, and
the control unit sets, based on the scheduled-plan history information, the predetermined time point on a golf-course basis such that a golf course having a lower rate of scheduled plan has a larger interval between the predetermined time point and the predetermined date.

5. The information processing apparatus according to claim 1, wherein
the storage unit stores user information including resident area information of a user, and reservation history information of past golf plans on a golf-course basis and on a user basis, and
the control unit
accepts, based on the user information and the reservation history information, a reservation for a golf plan in which a golf course group is specified, the golf course group including a plurality of golf courses for which the user has made a reservation two times or more among a plurality of golf courses in a predetermined area corresponding to the resident area information, via the first website from each of the user terminals through the communication unit, and
schedules a golf plan to be held, the golf plan being started at the first tee time in a first golf course of the golf course group, when the reservations from the predetermined number of users are accepted at a time point before the predetermined time point.

6. The information processing apparatus according to claim 5, wherein
the control unit schedules the golf plan to be held, the golf plan being started at the first tee time in the first golf course, when a sum of the number of reservations for the golf plan via the first website and the number of reservations for the golf plan via the second website reaches the predetermined number at a time point after the predetermined time point.

7. An information processing method, comprising:
storing, by a storage unit of an information processing apparatus, plan information on a golf plan scheduled to be held when reservations from a predetermined number of users are accepted;
accepting, by a communication unit of the information processing apparatus, a reservation for a golf plan in which a tee time group including a plurality of tee times on a predetermined date is specified, via a first website from each of the user terminals;
scheduling, by a control unit of the information processing apparatus, the golf plan to be held, the golf plan being started at one tee time selected from the tee time group, when the reservations from the predetermined number of users are accepted;
sending, by the communication unit, a reservation acceptance request to another information processing apparatus, the reservation acceptance request requesting acceptance of a reservation for the golf plan via a second website, when the golf plan is not scheduled to be held via the first website at a predetermined time point before the predetermined date; and
scheduling, by the control unit, the golf plan to be held, the golf plan being started at the one tee time, when a sum of the number of reservations for the golf plan via the first website and the number of reservations for the golf plan via the second website reaches the predetermined number.

8. (canceled)

9. The information processing method according to claim 7, further comprising
scheduling, by the control unit, a golf plan to be held, the golf plan being started at a second tee time selected from the tee time group excluding the first tee time, when the number of reservations for the golf plan via the first website reaches the predetermined number after the golf plan started at the first tee time is scheduled to be held and at a time point before the predetermined time point.

10. The information processing method according to claim 7, further comprising
scheduling, by the control unit, a golf plan to be held, the golf plan being started at a second tee time selected from the tee time group excluding the first tee time, when a sum of the number of reservations for the golf plan via the first website and the number of reservations for the golf plan via the second website reaches the predetermined number after the golf plan started at the first tee time is scheduled to be held and at a time point after the predetermined time point.

11. The information processing method according to claim 7, further comprising:
storing, by the storage unit, scheduled-plan history information of past golf plans on a golf-course basis; and
setting, by the control unit, based on the scheduled-plan history information, the predetermined time point on a golf-course basis such that a golf course having a lower rate of scheduled plan has a larger interval between the predetermined time point and the predetermined date.

12. The information processing method according to claim 7, further comprising:
storing, by the storage unit, user information including resident area information of a user, and reservation history information of past golf plans on a golf-course basis and on a user basis;
accepting, by the control unit, based on the user information and the reservation history information, a reservation for a golf plan in which a golf course group is specified, the golf course group including a plurality of golf courses for which the user has made a reservation two times or more among a plurality of golf courses in a predetermined area corresponding to the resident area information, via the first website from each of the user terminals through the communication unit; and
scheduling, by the control unit, a golf plan to be held, the golf plan being started at the first tee time in a first golf course of the golf course group, when the reservations from the predetermined number of users are accepted at a time point before the predetermined time point.

13. The information processing method according to claim 12, further comprising
scheduling, by the control unit, the golf plan to be held, the golf plan being started at the first tee time in the first golf course, when a sum of the number of reservations for the golf plan via the first website and the number of reservations for the golf plan via the second website reaches the predetermined number at a time point after the predetermined time point.
